(19) United States
(12) Patent Application Publication
(10) Pub. No.: US 2011/0231891 A1
(43) Pub. Date: Sep. 22, 2011

(54) Systems and Methods for Expression of Disassociation with Online Content

(76) Inventor: Tom C. Tovar, San Francisco, CA (US)

(21) Appl. No.: 12/896,823

(22) Filed: Oct. 1, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 21/00

(52) U.S. Cl. 726/1

(57) ABSTRACT

Systems and methods are provided for expression of disassociation with online content, including a user interface module to provide a user interface between a network user with administrative authority and an Internet service and a communication module to receive disassociation parameters for a disassociation policy for the Internet service. The disassociation parameters may include a name associated with an Internet content and a message corresponding to the Internet content. The name may be indicated as a website category or an affiliated website. The system may further include a confirmation module to confirm the disassociation policy with the network user with administrative authority, a policy generating module to establish, based on the disassociation parameters, the disassociation policy for the network, and a policy enforcement module to apply the disassociation policy to a user request to access the Internet content. The policy enforcement module may determine whether or not the disassociation policy is in effect to block the Internet content and provide the network user with the message corresponding to the Internet content.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

This application relates generally to data processing and more specifically to systems and methods for expression of disassociation with online content.

### BACKGROUND

Many Internet users enjoy expressing themselves online. Some write about their thoughts and perspectives in hope of influencing other people's views. These users may be highly opinionated and passionate about their beliefs. However, their impact on other people's views and actions may be limited, leaving them with a desire to voice their opinions in a way that will have an effect stronger than merely blogging about their experiences.

Even those users who are more temperate in their expressions would be willing to influence other people's actions if an opportunity presented itself. For example, if for any reason users wish others to avoid a service, product, or company, they may post their opinion by writing on one of the popular social networking websites. However, such postings typically do little to influence other people actions.

Users who wish to voice their opinions may attempt to block an Internet content by using content filtering software. However, the rationale behind such blocking will not be obvious to the network users prevented from accessing the Internet content.

### SUMMARY OF THE INVENTION

Various exemplary embodiments of the present invention illustrate systems and methods for expression of disassociation with online content. The expression of disassociation may apply to Internet service delivered to the home or business of the end user.

The system may provide policies that guide various user queries. Various embodiments of the systems and methods may include policy modules implementing expression of disassociation with online content. In one exemplary embodiment, a system is provided for expression of disassociation with online content, the system comprising a user interface module to provide a user interface between a network user with administrative authority and an Internet service and a communication module to receive disassociation parameters for a disassociation policy for the Internet service from the network user with administrative authority via the user interface.

The disassociation parameters may include a name associated with an Internet content and a message corresponding to the Internet content. The name may be indicated as a website category or an affiliated website. The system may further include a confirmation module to confirm the disassociation policy with the network user with administrative authority, a policy generating module to establish, based on the disassociation parameters, the disassociation policy for the network, and a policy enforcement module to apply the disassociation policy to a user request to access the Internet content. The policy enforcement module may determine whether or not the disassociation policy is in effect to block the Internet content and provide the network user with the message corresponding to the Internet content.

The system may include a user interface that allows the end user to personalize the content, and conditions of use, of the Internet service delivered. The user interface may operate between an end user and an Internet service provider. For purposes of this disclosure, the definition of Internet service provider will include any service or technology that provides a connection to the Internet. Examples of such technologies include, but are not limited to, traditional Internet service providers (ISPs), telecommunications companies, cable operators, mobile operators, network operators, and any other provider of wired or wireless access to Internet services. The system may be set up to run to utilize a DNS (Domain Name System) server, resolver, or a cloud based networking system.

The system may include one or more policy applications that allow a user to selectively manage at least a portion of an Internet service received by that end user or home network. The policy applications may be discrete applications and may be single purpose applications. The applications may be configured to meet the needs, rules, and behaviors desired by the end user.

The user may select one or more policy applications from a selection menu to provide an individualized Internet experience for the end user or his household.

The end user may select the policy applications that he wants to apply to his Internet service. The selections may be made using at least one of the Internet access devices available to the user or a user device and the user interface. The policies contained in the policy applications are applied to the Internet service that is supplied to the end user. Policies may include specific sites that can or cannot be accessed. Policies may also include time and duration of access, and limitations and restrictions specific to a given user or to the home network generally. It should be noted that the policy applications may be used to not only prohibit undesired behaviors, but may also be used to encourage desired behaviors. Other users within a home network may be redirected to sites other than those chosen based on a policy application applied by the user.

Feedback about the Internet service may be made available to the end user, such as to a person designated as the administrator of the system. The feedback may include a listing of sites that are accessed, access attempts for sites that are blocked, duration and time of use of each site, and which access device was used to access each site. The feedback may further include identification of the specific user who accessed the Internet.

Information about the personalization settings of an end user may be shared with third parties. A user may publish to friends or other third parties the policy applications they are using, and/or which policies he has in place. Similarly, the user may access information from third parties, such as which policies they are using, which policy applications they find useful, and so forth.

### BRIEF DESCRIPTION OF THE DRAWINGS

Exemplary embodiments are illustrated by way of example and not limitation in the figures of the accompanying drawings, in which like references indicate similar elements.

FIG. 1 is a block diagram of a disassociation policy engine, in accordance with various embodiments of the present technology.

FIG. 2 illustrates a flow chart of a method for expression of disassociation with online content.

FIG. 3 is a screenshot of a description associated with a disassociation policy application.

FIG. 4 is a screenshot of a configuration webpage to provide configuration parameters associated with a disassociation policy.]

FIG. 5 is a screenshot of a confirmation webpage to confirm disassociation policy settings.

FIG. 6 is a screenshot of a block webpage that can appear in the event that an Internet content is associated with the disassociation policy.

FIG. 7 is a block diagram of a Domain Name Server (DNS) server environment.

FIG. 8 is a block diagram of a system within which a disassociation policy is implemented.

FIG. 9 is a computing system that may be used to implement the methods for restricting online access.

### DETAILED DESCRIPTION

Systems and methods for expression of disassociation with online content, in some exemplary embodiments, may allow a user with administrative authority over a network to block an Internet content associated with a website or group of related websites and publish that decision to the network users prevented from accessing the Internet content. This may provide the user with administrative authority with a mechanism and a forum to channel discontent. Thus, the systems and methods may allow the user with administrative authority to express and enforce a disassociation with, for example, products, services, corporations, organizations, commercial offerings, content, and so forth.

Besides specifying the content to be blocked under such a disassociation policy, the user with administrative authority may document the rationale underlying his or her discontent as part of the parameters provided for configuration of the disassociation policy. The rationale may be provided as a message to the network users. In some exemplary embodiments, such a message may be moderated by other users with administrative authority in order, for example, to screen offensive postings.

Thus, a user with administrative authority may block access to a chosen website and write a message describing his or her disassociation with the respective content or company. The block may occur at a household or local network level. The user with administrative authority may be provided with an option to block a specific website and its related websites. The systems and methods for expression of disassociation with online content may be capable of discerning related websites (either by category or association) in order to fulfill the related site option.

Administrator-defined Internet content may also include Internet content collaboratively determined to be subject to disassociation by a group of end users invited by the administrator to collaborate on the propriety of Internet content used in the disassociation policy. The administrator may, before or after the administrator creates the administrator's own disassociation policy, invite the administrator's family members, friends, colleagues or any group of combination of groups and individuals to identify Internet content to be used by the administrator in creating the administrator's own mediation policy. These invitees may or may not be users of the Internet service but will be allowed to contribute to the administrator's disassociation policy via the user interface of the Internet service. The administrator may choose to moderate the contributions of individuals or groups invited by the administrator to contribute to the administrator's disassociation policy. The administrator may also, before or after the administrator creates the administrator's own disassociation policy, join an existing group of users of the Internet service and apply the determinations of propriety of Internet content by a group to the administrator's own disassociation policy. Where there is an existing group that the administrator joins for purposes of creating a disassociation policy, the administrator may choose to import the contributions of other groups once or subscribe to these groups to reduce the configuration burden of creating a disassociation policy. After the administrator creates the administrator's own disassociation policy, the administrator may publish the administrator's disassociation policy to be used and/or subscribed to by other users of the Internet service. In such case, other users of the Internet service may import the contributions of administrator once or subscribe to the administrator's disassociation policy for use in their own disassociation policies. It is understood that via this collaboration two or more user-administrators may combine their disassociation policies to create one disassociation policy that may be used by these and other administrators of the Internet service.

The following detailed description includes references to the accompanying drawings, which form a part of the detailed description. The drawings show illustrations in accordance with exemplary embodiments. These exemplary embodiments, which may be referred to herein as “examples,” are described in enough detail to enable those skilled in the art to practice the present subject matter. The embodiments can be combined, and other embodiments can be formed, by introducing structural and logical changes without departing from the scope of what is claimed. The following detailed description is, therefore, not to be taken in a limiting sense and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Generally speaking, an administrator may create and enforce mediation polices for one or more end users that utilize computing devices coupled to an Internet service delivered to a location such as a home, residence or place of business or campus. The term “administrator” may include not only individuals, such as parents, but also any individual creating a mediation policy regarding the Internet service delivered to end users. It will be understood that an administrator may also be an end user, although end users who are not also administrators may not create or apply policies.

It will be further understood that because of the diversity of computing devices that may connect to the Internet service, the policy may be applied to the Internet service rather than requiring the policy to affect each computing device individually, such as a mediation application resident on each computing device. In various exemplary embodiments a policy may also reside as a stand alone application on one or more of the computing devices.

Exemplary user devices for use with the disclosed systems may have an app. As used herein, an app shall be defined as a module including a user interface to an Internet service. The app may further include one or modules included in the Internet service. An app may be downloaded and installed on a user's computing device, including mobile devices. Users may define mediation policy via a user device, such as through the user interface. Some embodiments of the present invention do not require software to be downloaded or installed locally to the user device and, accordingly, do not require the user to execute a de-install application to cease use of the system.

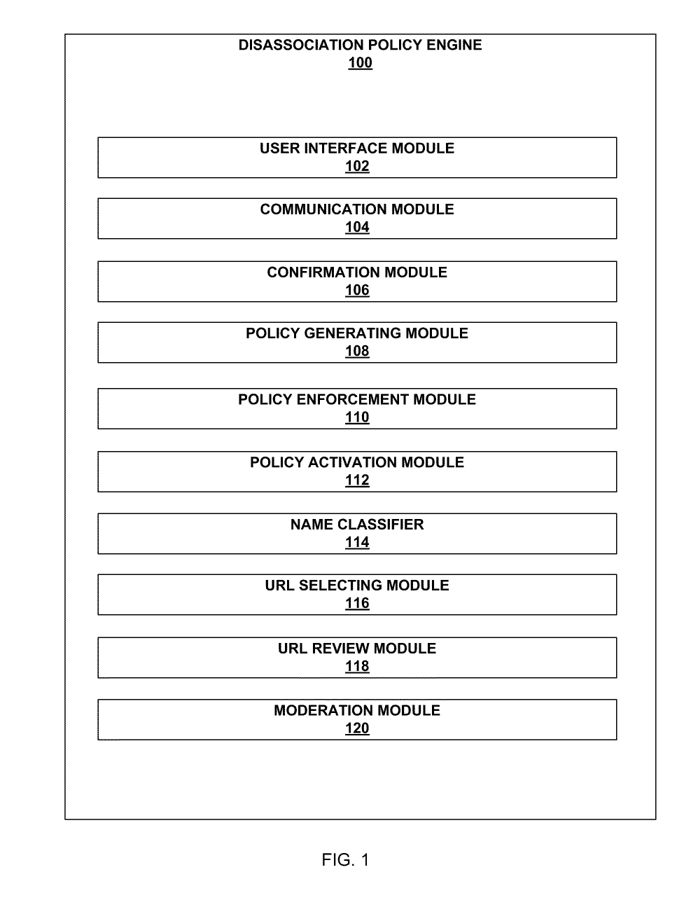

FIG. 1 is a block diagram of a disassociation policy engine 100, in accordance with various exemplary embodiments of the technology. Alternative embodiments of the disassociation policy engine 100 may comprise more, less, or functionally equivalent modules. In some exemplary embodiments, the disassociation policy engine 100 may comprise a user interface module 102, a communication module 104, a confirmation module 106, a policy generating module 108, a policy enforcement module 110, a policy activation module 112, a name classifier 114, a Uniform Resource Locator (URL) selecting module 116, a URL review module 118, and a moderation module 120. It will be appreciated by one of ordinary skill that examples of the foregoing modules may be virtual and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

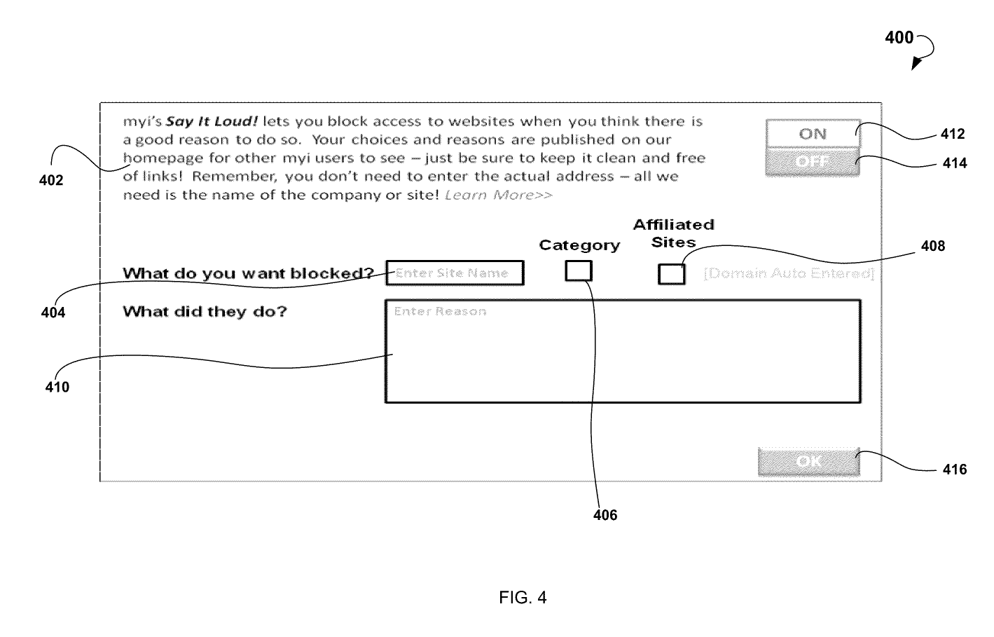

A network user 760 with administrative authority may desire to express a digital disassociation with products, services, corporations, organizations, commercial offerings, content, and so forth. To put this desire into action, the network user 760 with administrative authority may utilize a user interface 810, generated by the user interface module 102, to configure the disassociation policy with various parameters. The user interface module 102 may also enable the network user 760 with administrative authority to activate and deactivate the disassociation policy, for example, by using ON and OFF buttons. A network user 760 being targeted by the disassociation policy may utilize the user interface module 102 to review the disassociation policy and to either go back or be taken to his or her homepage. An exemplary configuration of the disassociation policy is described in more detail below with reference to FIG. 4.

In one example, the network user 760 with administrative authority may have a desire to advocate a certain cause. He or she may have a strong opinion and be willing to enforce this opinion by blocking an Internet content within a network. For example, the network user 760 with administrative authority may want to only support the local economy and therefore may decide to block a megastore (e.g., Wal-Mart) or only support US car makers and block “foreign” car manufacturing sites (e.g., BMW). If the network user 760 with administrative authority has decided to take overt actions of blocking the Internet content within the household, he or she may want to share their decision in order to encourage others to act.

In another example, the network user 760 with administrative authority, as a parent, may be willing to be more vocal about the things he or she supports and the things that, in his or her view, may have a negative impact on a family. There may be many online communities where parents can provide their opinion, share their experiences, and ask for advice.

The systems and methods for expression of disassociation with online content may provide parents with the means to continue letting their voices be heard and help other parents facing the same situations. Additionally, the systems and methods for expression of disassociation with online content may present another way for parents to influence the content allowed in the house. Thus, the network user 760 with administrative authority may block a Internet content and publish the information related to the blocking.

In yet another example, certain organizations may wish to publish a list of websites that they have chosen block. For example, PETA may wish to block all online content related to companies that are cruel to animals or use fur in their products. Religious organizations, including local churches, may want to block the websites that go against their beliefs and share that list with their followers. The disassociation policy may be established at a network level (e.g., a home and an organizational network).

The communication module 104 may be configurable to provide a communication channel between the disassociation policy engine 100 and various other components. Additionally, the communication module 104 may enable direct exchange of information between various modules of the disassociation policy engine 100. For example, the communication module 104 may facilitate receiving disassociation configurations provided by the network user 760 with administrative authority via the user interface 810.

When the network user 760 with administrative authority submits the configurations associated with the disassociation policy, the policy generating module 108 may generate an appropriate disassociation policy. For example, in response to the network user 760 with administrative authority entering “animal cruelty” as a category of Internet content he would like to discourage and checking the category check box, the policy generating module 108 may generate a disassociation policy that will block the network user 760 from accessing websites falling into the animal cruelty category and publish the rationale behind such blocking.

In some exemplary embodiments, the confirmation module 106 may be configurable to confirm the disassociation policy with the network user 760 with administrative authority after the configurations are saved and/or enabled and the policy generating module 108 generates the disassociation policy. When the network user 760 attempts to access the website which falls within the disassociation policy, the disassociation policy may be enforced by the policy enforcement module 110. It should be appreciated that in some exemplary embodiments, saving disassociation policy configurations may not automatically activate the associated disassociation policy. Therefore, the policy activation module 112 may be utilized to activate the disassociation policy. The policy activation module 112 may also be utilized to deactivate the disassociation policy if the network user 760 with administrative authority decides to terminate the disassociation policy.

In order to specify the disassociation policy, the network user 760 with administrative authority may enter a name and, optionally, indicate whether the name is a category. Additionally, the network user 760 with administrative authority may indicate whether he or she wants affiliated websites to be blocked as well.

In some exemplary embodiments, the name classifier 114 may be utilized to determine the type of the input received from the network user 760 with administrative authority. As already mentioned above, the network user 760 with administrative authority may explicitly indicate the type of the input by selecting the category checkbox. Based on whether the network user 760 with administrative authority wishes to enforce the disassociation policy with respect to a specific website or a website category, the URL selecting module 116 may determine which website or website category is most closely aligned with the request of the network user 760 with administrative authority.

To ensure that websites, website categories, an/or affiliated websites are correctly selected by the URL selecting module 116, the URL review module 118 may enable the network user 760 with administrative authority to review and modify the one or more URLs associated with the disassociation policy. If the network user 760 with administrative authority does not believe that the selected URLs align with his or her intended content, he or she can modify the selection by removing and/or adding URLs and/or categories of URLs. The moderation module 120 may be utilized by one or more network users 760 with administrative authority to ensure that the content of the message provided as the parameters for the disassociation policy are acceptable (e.g., are not offensive).

When the network user 760 attempts to access a website, the policy enforcement module 110 may determine that the disassociation policy is active and that the intended content is covered by the disassociation policy. Upon such determination, the policy enforcement module 110 may block the content association with the disassociation policy. A block webpage may appraise the network user 760 of the policy behind the blocking by providing an explanation. Based on observed results, the network user 760 with administrative authority may wish to modify the parameters throughout the course of the use of the disassociation policy.

The ability to make modifications may be important because the network user 760 with administrative authority may not be completely sure whether the initial settings cover the appropriate content. Instead, the network user 760 with administrative authority may make educated guesses as to what websites or website categories are problematic with respect to one or more network users 760. If the initial disassociation policy does not cover the appropriate content, the network user 760 with administrative authority may wish to change or apply additional settings to the disassociation policy. This trial and error process may be repeated until the desired results are achieved.

Thus, the network user 760 with administrative authority may alter the Internet content that is covered by the disassociation policy by accessing the settings and adding new Internet content and/or deselecting the existing Internet content.

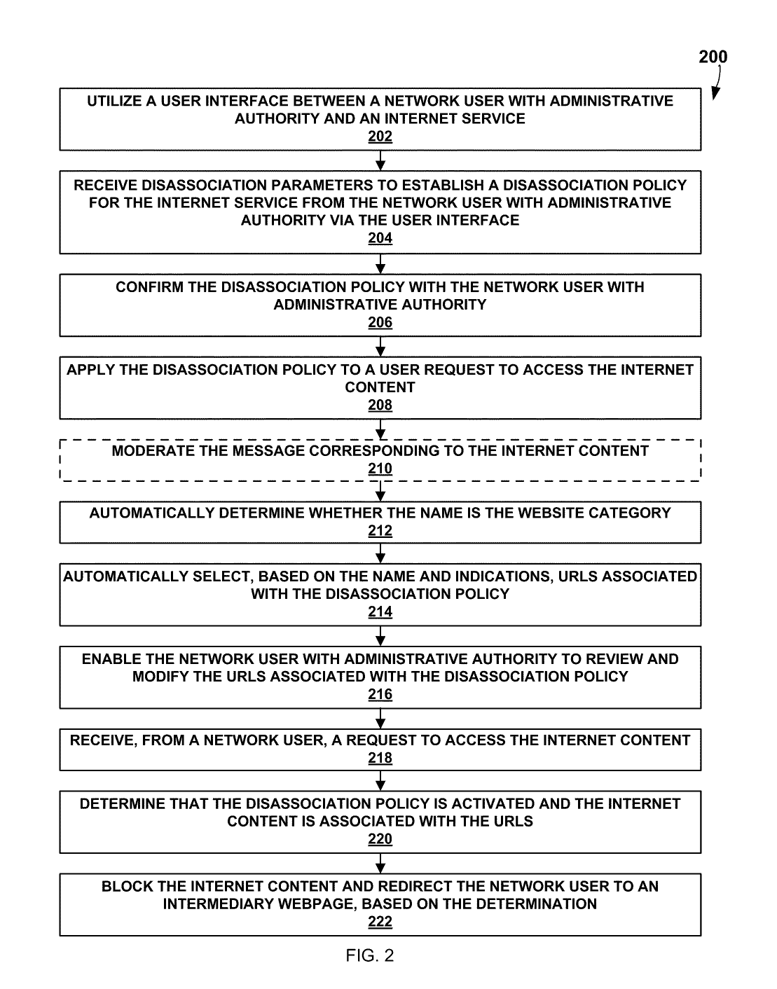

FIG. 2 illustrates a flow chart of a method 200 for expression of disassociation with online content, in accordance with an exemplary embodiment. The method 200 may be performed by processing logic that may comprise hardware (e.g., dedicated logic, programmable logic, microcode, etc.), software (such as run on a general-purpose computer system or a dedicated machine), or a combination of both. In one exemplary embodiment, the processing logic resides at the disassociation policy server 100 as illustrated in FIG. 1.

The method 200 may be performed by the various modules discussed above with reference to FIG. 1. Each of these modules may comprise processing logic. The method 200 may commence at operation 202 with the user interface module 102 establishing the user interface 810 between the network user 760 with administrative authority and an Internet service. At operation 204, the communication module 104 may receive from the network user 760 with administrative authority disassociation parameters to establish a disassociation policy for the Internet service, including a name associated with an Internet content and a message. The name may be indicated by one or more indications as a website category and/or an affiliated website.

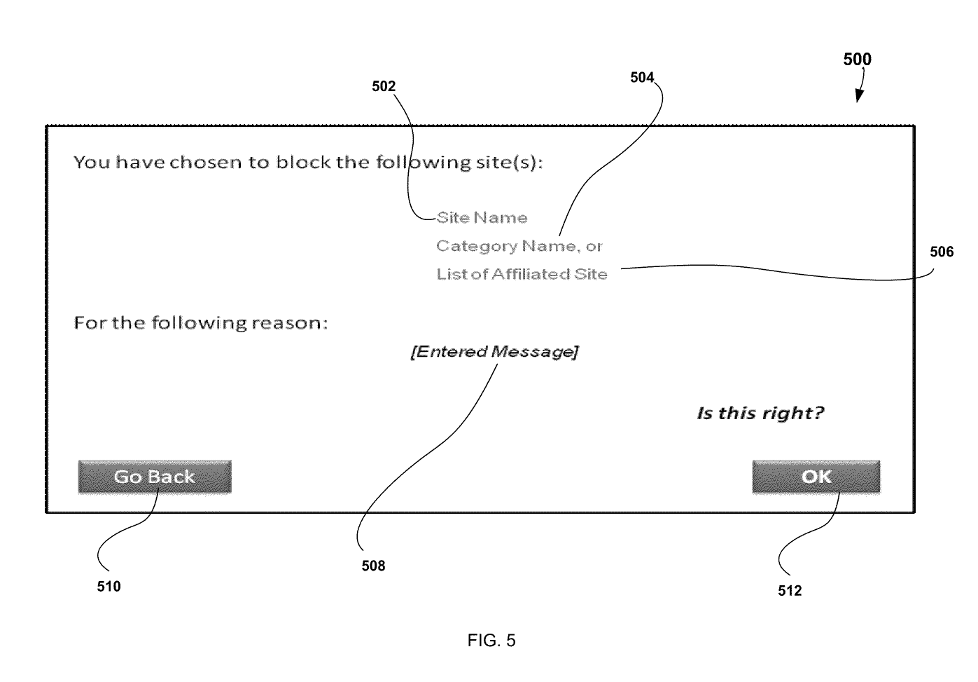

At operation 206, the confirmation module 106 may confirm the disassociation policy with the network user 760 with administrative authority by displaying a confirmation website. The confirmation website is discussed in more detail with reference to FIG. 5. Using the confirmation website, the network user 760 with administrative authority may confirm the disassociation policy as specified or go back to the configuration webpage and modify the settings. At operation 208, the policy enforcement module 110 may apply the disassociation policy to the user 760 request to access an Internet content. The policy enforcement module 110 may determine whether or not the disassociation policy is in effect to block the Internet content and provide the network user 760 with the message corresponding to the Internet content.

If another user 760 with administrative authority wishes to moderate the message provided in the parameters, at operation 210 the moderation module 120 may provide a mechanism for moderating the disassociation policy. Thus, another user 760 with administrative authority may alter the parameters provided for the disassociation policy. At operation 212, the name classifier 114 may automatically determine whether the name the name is a website category. At operation 214, the URL selecting module 116 may select, based on the name, one or more URLs associated with the disassociation policy.

At operation 216, the URL review module 118 may enable the network user 760 with administrative authority to review and modify the one or more URLs associated with the disassociation policy. At operation 218, the communication module 104 may receive, from the network user 760, a request to access the Internet content. At operation 220, the policy enforcement module 110 may determine that the disassociation policy is activated and the Internet content is associated with the one or more URLs.

If the policy enforcement module 110 determines at operation 220 that the disassociation policy is activated and the Internet content is associated with the one or more URLs, at operation 222, the policy enforcement module 110 may block the internet content and redirect the network user to a block webpage. The block page may include a message from the network user 760 with administrative authority explaining the rationale behind the disassociation policy.

The disassociation policy engine 100 may send the network user 760 with administrative authority a reporting log compiling information displayed on the block page, the website that prompted the block page, and the message delivered. In addition to the aforementioned data captures, the reporting log may also retain an aggregated number of messages sent (e.g., on an annual basis), websites that prompted the messages, messages that are sent, and actions taken by the network user 760 recipient.

The settings associated with the disassociation policy, which may include website redirection settings and custom messages, may be saved and maintained until the network user 760 with administrative authority decides to change the settings or disable the disassociation policy.

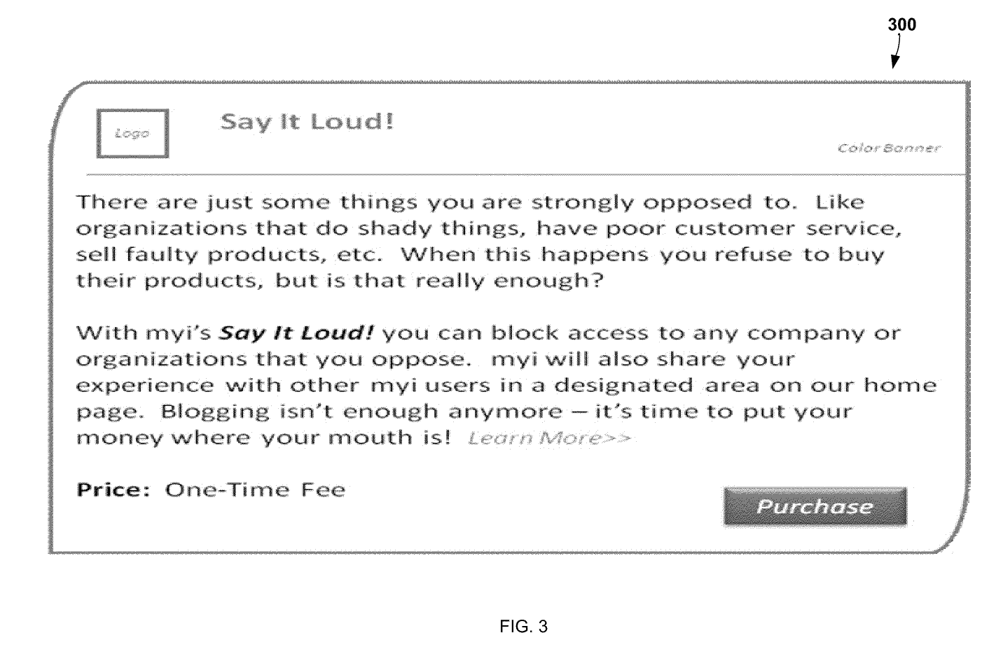

FIG. 3 is a screenshot of a description 300 associated with a disassociation policy application, in accordance with an exemplary embodiment. The description 300 may allow the network user 760 with administrative authority to receive information concerning the disassociation application. The description 300 may generally describe what the disassociation policy does. As shown in FIG. 3, the description 300 may begin with one or more sentences describing the functionality of the disassociation policy. In some exemplary embodiments, the description 300 may outline steps in configuring settings for the disassociation policy.

FIG. 4 is a screenshot of a configuration webpage 400 to provide configuration parameters associated with the disassociation policy. The configuration webpage 400 may be utilized by the network user 760 with administrative authority to provide configuration parameters associated with the disassociation policy, in accordance with an exemplary embodiment. In some exemplary embodiments, the configuration webpage 400 may comprise a description text 402, a name textbox 404, a “Category” checkbox 406, an “Affiliated Sites” checkbox 408, a message textbox 410, an “ON” button 412, an “OFF” button 414, and an “OK” button 416. The functionality of the disassociation policy may be accessible through the configuration webpage 400. The configuration webpage 400 may allow the network user 760 with administrative authority to select one or more websites that they wish network users 760 to abstain from.

The description text 402 may include a brief summary of what the disassociation policy does and how the network user 760 with administrative authority may configure it. The description text 402 may begin with one or two sentences describing the functionality of the disassociation policy. The description text 402 may then outline steps in configuring the settings of the disassociation policy. The description text 402 may include a “Learn More” link that allows the network user 760 to get more detailed information.

The network user 760 with administrative authority may block specified content by entering a company or website name in the name textbox 404. After entering the name in the name textbox 404, the network user 760 with administrative authority may narrow the requested content by clicking either the “Category” checkbox 406 or the “Affiliated Sites” checkbox 408, when applicable. If the network user 760 with administrative authority does not select either of these boxes, the disassociation policy engine may assume that the network user 760 has inputted a website.

After entering the content to be blocked into the name textbox 404, the network user 760 with administrative authority may enter an explanation as to why he or she is taking this action in the message box 410. The explanation may automatically change its size to accommodate the text that is being entered. The websites defined by the message and optional indications of the category and the affiliated websites may prompt the block webpage to appear and to display the message.

After the name and the accompanying indications are entered in the name textbox 404, the URL selecting module 116 may automatically populate a URL of a website, category, and/or affiliated websites (if a category and/or affiliated websites were selected) that aligns most closely with the input provided by the network user 760 with administrative authority.

If the network user 760 with administrative authority determines, upon review, that the selections made by the URL selecting module are incorrect, the network user 760 with administrative authority may click on the selections directly and be presented with a drop down menu filled with other possible selections. After the network user 760 with administrative authority has made their site selection(s), he or she may click the “OK” button 416 to have the settings stored. After clicking the “OK” button 416, the network user 760 with administrative authority may receive a confirmation overlay as outlined below with reference to FIG. 5.

It should be noted that clicking the “OK” button may not automatically enable the disassociation policy. If the network user 760 with administrative authority users inputs selections but neglects to enable the disassociation policy (e.g., by clicking the “ON” button 412), the disassociation policy engine 100 may present an overlay asking whether the user would like to enable the disassociation policy before navigating away from the configuration webpage 400.

FIG. 5 is a screenshot of a confirmation webpage 500, which may be utilized to confirm disassociation policy settings, in accordance with an exemplary embodiment. The confirmation webpage 500 may include a website name 502, a category name 504, one or more affiliated websites 506, a message 508, a “Go Back” button 510, and an “OK” button 512. After the network user 760 with administrative authority clicks the “OK” button 416, they may be presented with the confirmation webpage 500 that asks them to confirm the website name 502, the category name 504, the one or more affiliated websites 506 and the message 508 provided at the configuration webpage 400. If the network user 760 with administrative authority decides that the information is correct, he or she may click the “OK” button 512, which may save the settings provided at the configuration webpage 400 and close the confirmation webpage 500. If, on the other hand, the network user 760 with administrative authority decides that any of the presented information is incorrect, the network user 760 with administrative authority may be able to click the “Go Back” button 510 to edit their selections in the configuration webpage 400.

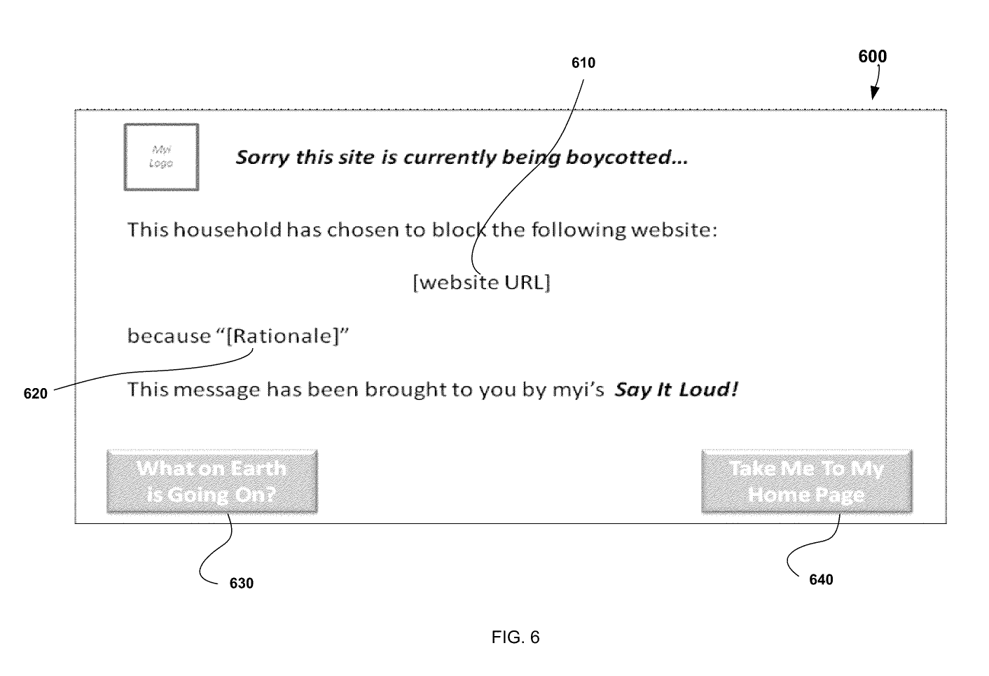

FIG. 6 is a screenshot of a block webpage 600 that may appear in the event that a Internet content is associated with the disassociation policy, in accordance with an exemplary embodiment. The block webpage 600 may comprise a website URL 610, a message 620, a “What on Earth is Going On” button 630, and a “Take Me to My Home Page” button 640. If the network user 760 attempts to access a website in the DNS network 740 that is blocked the disassociation policy, he or she may be re-directed to the block webpage 600 instead of the requested website. The content of the block webpage 600 may inform the network user 760 that his or her attempt to access the website has been denied, that the block was the result of the disassociation policy, and provide the network user 760 the ability to learn more about why the website request was blocked via the “What on Earth is Going On” button 630. Additionally, the block webpage 600 may inform the network user 760 that the network user 760 with administrative authority has requested that this action be taken.

The message 620 may provide the network user 760 with a brief explanation of why he or she has been presented with the block page 600. The network user 760 may be presented with the website URL 610 he or she was trying to access. Clicking the “What on Earth is Going On” button 630 may take the network user 760 to a description webpage that may discuss in greater detail the disassociation policy. By clicking the “Take Me to My Home Page” button 640, the network user 760 may be taken to his or her designated home page. The home page may be determined through the browser settings.

The systems and methods described above may typically be resident in an Internet service or a DNS network. The systems and methods described may also be implemented in plug-in utilities, gateway devices, cable modems, proxy servers, set top boxes, and network interface devices.

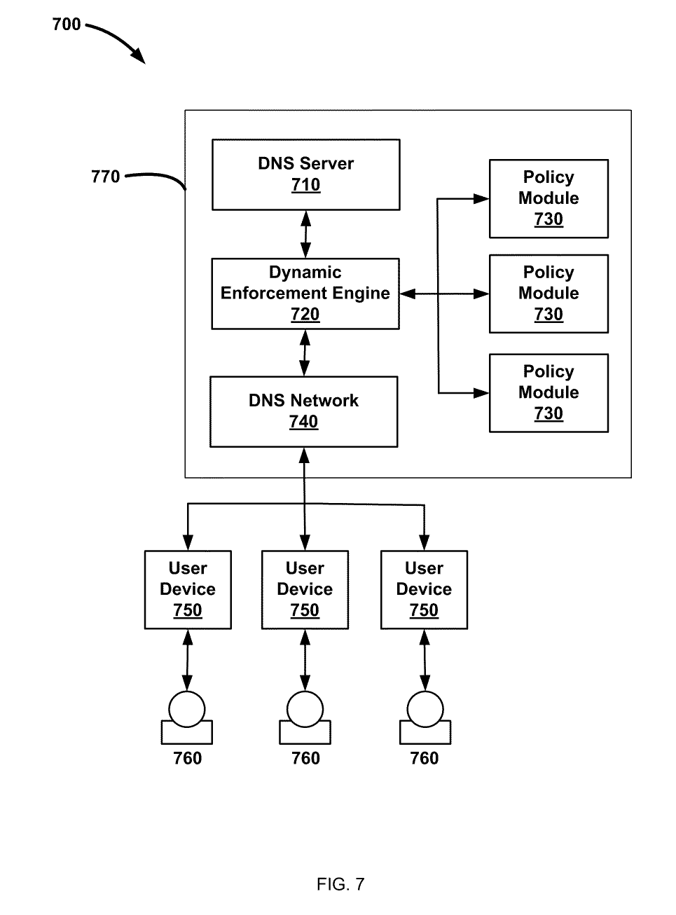

FIG. 7 illustrates an exemplary Internet service system 700, with a DNS Server, that may be utilized to support the above described systems and methods.

A DNS Server 710 may operate in conjunction with a dynamic enforcement engine 720. The dynamic enforcement engine 720 may operate in conjunction with one or more policy modules 730 to establish any applicable polices at the DNS Server 710 level. The content rules are applied to received user queries, and determine the content that is delivered by the DNS network 740 through various user devices 750 to the network users 760.

The dynamic enforcement engine 720 may generate its policy engine on instructions received from one or more policy modules 730. Each policy module 730 may be constructed to provide various types and levels of services to the DNS network 740. In various embodiments, a policy module 730 may be configured to handle queries directed to subjects including, but not limited to, malicious domain redirection, user access redirection, non-existent domain redirection, and data collection or analysis.

It will be recognized by those skilled in the art that the elements of DNS service 770 may be hosted either locally or remotely. In addition to residing in the DNS service 770, one or more of the DNS network 740, the dynamic enforcement engine 720, and the policy modules 730, and any combination thereof, may be resident on one or more user devices 750.

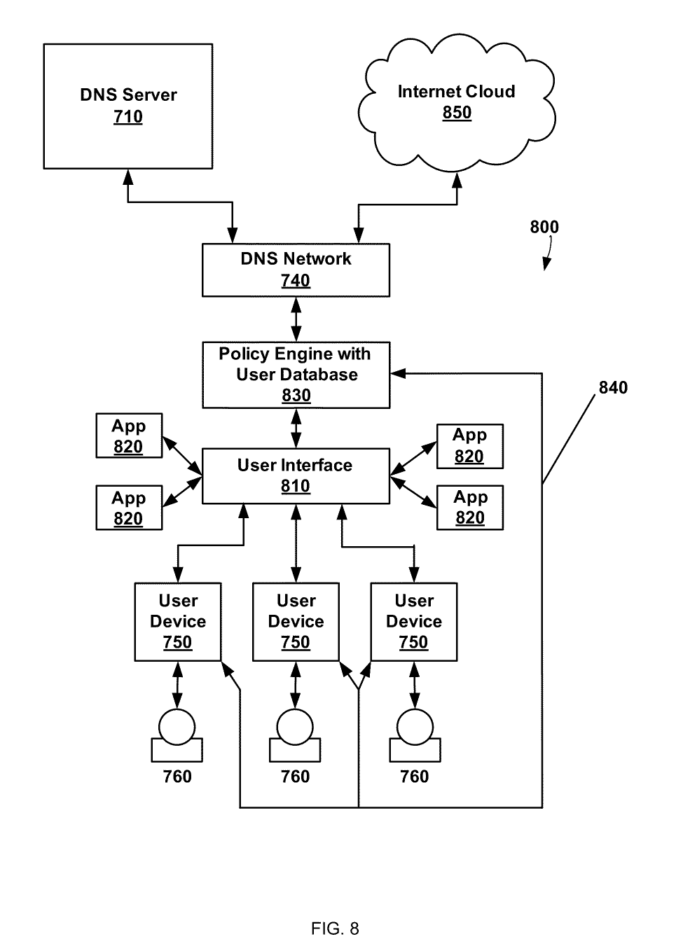

FIG. 8 shows a schematic layout of an exemplary system 800 for implementing direct and variable network user control. FIG. 8 illustrates that the system 800 may operate installed on a DNS Server 710, or with a cloud 850 based installation.

The system 800 utilizes a user interface 810. The user interface 810 may be implemented in many embodiments. One specific implementation of the user interface 810 is as a web page.

The user interface 810 may be accessed by one or more user devices 750 operated by the users 760. The user interface 810 may be accessed through a gateway user device available to the users 760. Suitable user devices 750 include, but are not limited to desktops, personal computers (PCs), laptops, notebooks, tablets, gaming devices, Smartphones music players, automobile computer systems, and Internet enabled Televisions (TVs). The system 800 may also be deployed, accessed and controlled remotely through user devices 750, such as a Smartphones or other specialized access devices. A Smartphone may be defined as a phone with computing capability. A Smartphone may provide the user 760 with Internet access.

The user interface 810 provides a mechanism for one or more authorized users 760 to establish content policy for the Internet service. The user interface 810 operates between the user devices 750 present in the system 800 and the DNS network 740. Instructions resident on the user interface 810 therefore operate on the Internet service, by controlling at least a portion of the DNS resolutions via a dynamic policy engine 830, before the service reaches the displays of the user devices 750.

The user interface 810 provides the users 760 with access to one or more policy applications 820. The user interface 810 may provide access to a selection list to at least one authorized user 760. The authorized user 760 uses the selection list or some other menu mechanism to select those policy applications 820 that the user 760 chooses to apply to the system 800. The authorized user 760 may select any number of the available policy applications for use on the system 800 at any given time. In implementations utilizing Smartphones as the user device 750, the policy applications 820 are downloaded to the user device 750. The user device 750 then serves as the user interface 810 to communicate directly with the dynamic policy engine 830.

The policy applications 820 may prohibit access to specific Internet content. The policy applications 820 may also limit the time of day when users or selected users 760 may access certain Internet content. The policy applications 820 may also manage and analyze duration of access to various Internet content. It is important to note that the policy applications 820 do not simply provide blocking mechanisms by masking or enabling network controls, but rather mediate an Internet service received by the network user. As used herein, mediating the service may include any of blocking, constraining, enabling, redirecting, promoting, demoting, substituting, obscuring, limiting, interrupting, and restricting all or a portion of the Internet service. The policy applications 820 may provide notifications or alerts to one or more users 760 when Internet content is accessed. The policy applications 820 may also provide notification of frequency and duration of access of designated Internet content. The policy applications 820 may also be used to observe, substitute, enable, redirect users, reward behavior desired from the users by a system administrator, and so forth. The policy applications 820 may redirect users from a non-favored Internet content to a different Internet content. The policy applications 820 may also collect and transmit data characteristic of Internet use.

Access policies supplied by the policy applications 820 may apply to all network users 760 of the system 800, or the access policies may be specific to individual users or groups of network users 760. The policy applications 820 may be discrete, single purpose applications.

The policy applications 820 provide the users 760 with a mechanism to take various actions relative to their Internet service feed. The policy applications 820 also allow the users 760 to establish a dynamic policy engine 830 that includes a user database. The dynamic policy engine 830 is used to enforce rules associated with each policy application associated with individual network users, not simply block various inappropriate Internet contents from the Internet feed. Rather, the dynamic policy engine 830, controlled by the user interface 810 through user device(s) 750, is used to manage all aspects of the Internet experience for the users 760. In sum, the policy applications 820 may be used to configure the dynamic policy engine 830 to provide the users 760 with a mechanism to personalize the Internet experience. The policy applications 820 may be configured in combinations, and may each be separately configured.

The database in the dynamic policy engine 830 may be used to record and to notify network users 760 of various data relative to Internet access. The data collected from and provided to the users 760 may include records of access of specific Internet content, time spent on specific Internet content, time of day of access, data specific to individual users, and so forth.

It should also be noted that following an initial setup through the user interface 810 of the dynamic policy engine 830, a direct access 840 enforcement loop may be established between the dynamic policy engine 830 and the user devices 750. Subsequent accessing of the DNS network 740 utilizing the direct access 840 decreases response time in the system 800, thereby further enhancing the Internet experience of the users 760. Configurations of policy applications 820 that are selected by one or more users 760 designated as system administrators may remain in the user database of the dynamic policy engine 830 until such time as it may be modified by the system administrators. The system administrators may define multiple policy configurations, with a combination of policy applications 820, applicable to one or more network users 760 of the system 800. Each policy application 820 may be separately configurable as well. Policy configurations may vary based upon designated times, conditional triggers, or specific requests from the users 760 with administrative authority.

As indicated above, two discrete data flow paths may be established for the system 800. A first data path establishes a set of enforcement policies for the system 700. The first data path flows from at least one user device 750 through the user interface 810 to the policy enforcement engine 720. A second data path 840 may be utilized following the establishment of a set of policies for the system 800. The second data path 840 flows directly between the user device(s) 750 and the dynamic policy engine 830. Multiple sets of enforcement policies may be established and saved within the system 800 and implemented selectively by the users 760.

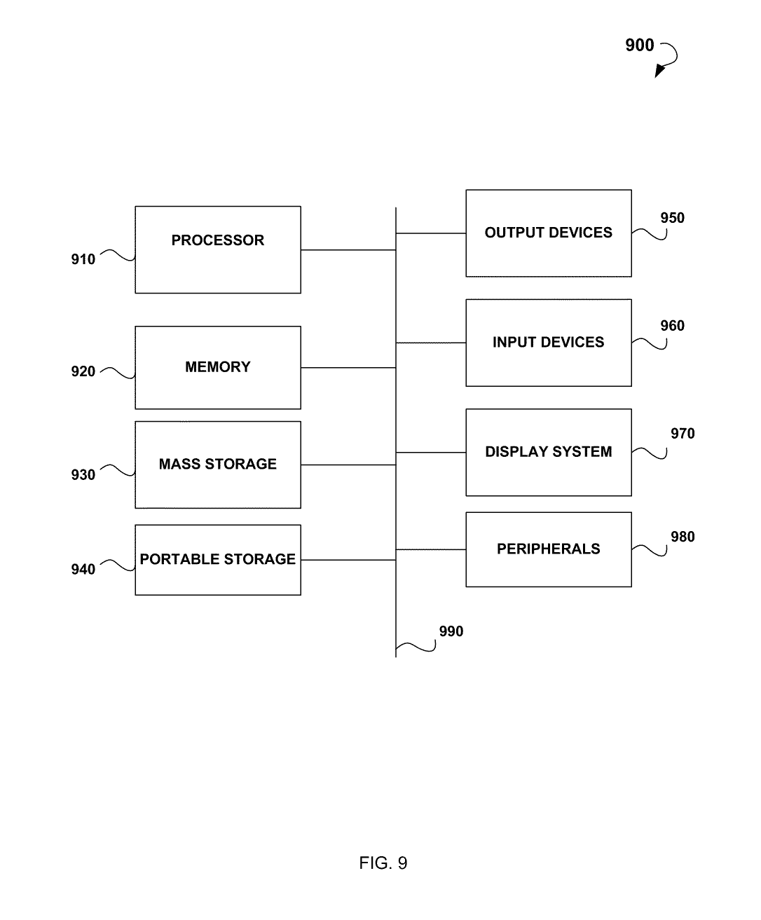

FIG. 9 illustrates an exemplary computing system 900 that may be used to implement an embodiment of the present invention. System 900 of FIG. 9 may be implemented in the context of user devices 750, DNS Server 710, Internet cloud 850, and the like. The computing system 900 of FIG. 9 includes one or more processors 910 and memory 920. Main memory 920 stores, in part, instructions and data for execution by processor 910. Main memory 920 can store the executable code when the system 900 is in operation. The system 900 of FIG. 9 may further include a mass storage device 930, portable storage medium drive(s) 940, output devices 950, user input devices 960, a graphics display system 970, and other peripheral devices 980.

The components shown in FIG. 9 are depicted as being connected via a single bus 990. The components may be connected through one or more data transport means. Processor 910 and main memory 920 may be connected via a local microprocessor bus, and the mass storage device 930, peripheral device(s) 980, portable storage medium drive(s) 940, and graphics display system 970 may be connected via one or more input/output (I/O) buses.

Mass storage device 930, which may be implemented with a magnetic disk drive or an optical disk drive, is a non-volatile storage device for storing data and instructions for use by processor 910. Mass storage device 930 can store the system software for implementing embodiments of the present invention for purposes of loading that software into main memory 920.

Portable storage medium drive 940 operates in conjunction with a portable non-volatile storage medium, such as a floppy disk, compact disk (CD) or digital video disc (DVD), to input and output data and code to and from the computer system 900 of FIG. 9. The system software for implementing embodiments of the present invention may be stored on such a portable medium and input to the computer system 900 via the portable storage medium drive(s) 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Suitable output devices include speakers, printers, network interfaces, and monitors.

Display system 970 may include a liquid crystal display (LCD) or other suitable display devices. Graphics display system 970 receives textual and graphical information and processes the information for output to the display device.

Peripheral devices 980 may include any type of computer support device to add additional functionality to the computer system. Peripheral device(s) 980 may include a modem or a router.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a PC, hand held computing device, telephone, mobile computing device, workstation, server, minicomputer, mainframe computer, or any other computing device. The computer can also include different bus configurations, networked platforms, multi-processor platforms, and so forth. Various operating systems can be used, including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a Central Processing Unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as system Random Access Memory (RAM). Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for exemplary, a floppy disk, a flexible disk, a hard disk, magnetic tape, any other magnetic medium, a CD-Read-only Memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” comprises any content that may be accessed by a user device including but not limited to one or more of web sites, domains, web pages, web addresses, hyperlinks, URLs, any text, pictures, and/or media (such as video, audio, and any combination of audio and video) provided or displayed on a web page, and any combination thereof. A disassociation policy may include any of blocking, constraining, enabling, redirecting, promoting, demoting, substituting, obscuring, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

1. A method of disassociation with online content, the method comprising:
utilizing a user interface between a network user with administrative authority and an Internet service;
receiving disassociation parameters to establish a disassociation policy for the Internet service from the network user with administrative authority via the user interface, wherein the disassociation parameters include an Internet site or category associated with an Internet content and a message to be delivered when the disassociated Internet content is requested; and
applying the disassociation policy to a network user request to access the Internet content, a policy enforcement module determining whether or not the disassociation policy is in effect to block the Internet content and to provide the network user with the message corresponding to the disassociated Internet content.

2. The method of claim 1, wherein the user interface provides a mechanism for activating and deactivating the disassociation policy.

3. The method of claim 1, wherein a keyword is used to generate a list of associated Internet content for inclusion in the disassociation policy.

4. The method of claim 1, further comprising enabling the network user with administrative authority to review and modify the one or more Internet sites or categories associated with the disassociation policy.

5. The method of claim 1, further comprising moderating the message corresponding to the Internet content.

6. The method of claim 1, wherein the disassociation policy is established for a home network.

7. The method of claim 1, wherein the disassociation policy is established by a group of otherwise unrelated network users.

8. The method of claim 1, wherein a network user can share a disassociation policy with at least one third party.

9. The method of claim 1, wherein each end user customizes the disassociation policy.

10. The method of claim 1, wherein the disassociation policy is published to the Internet service from sources external to the Internet service.

11. The method of claim 1, wherein the disassociation policy is established by third parties with specific interests or advocacy viewpoints.

12. The method of claim 1, wherein the Internet service logs and reports on attempts to access the Internet categories or Internet sites associated with the disassociation policy.

13. The method of claim 1, wherein the disassociation policy is imported from a third party.

14. The method of claim 2, wherein all users of the Internet service receive notification of activation or de-activation of disassociation policies.

15. The method of claim 1, wherein at least one element of the disassociation policy is resident on a DNS server.

16. The method of claim 1, wherein at least one element of the disassociation policy is enforced by the DNS server.

17. The method of 1, wherein the network user with administrative authority specifies different dissociation policies based on different locations.

18. The method of claim 1, wherein at least one element of the Internet service is resident on a user device.

19. The method of claim 1, wherein the mediation policy is created by a collaborative effort from more than one user.

20. The method of claim 19, wherein at least one user is not a user of the network to which the mediation policy is applied.

21. A system of disassociation with online content, the system comprising:
a user interface module to provide a user interface between a network user with administrative authority and an Internet service;
a communication module to receive disassociation parameters to establish a disassociation policy for the Internet service from the network user with administrative authority via the user interface, wherein the disassociation parameters include an Internet site or category associated with an Internet content and a message to be delivered when the disassociated Internet content is requested;
a policy generating module to establish, based on the disassociation parameters, the disassociation policy for the network; and
a policy enforcement module to apply the disassociation policy to a user request to access the Internet content, the policy enforcement module determining whether or not the disassociation policy is in effect to block the Internet content and to provide the network user with the message corresponding to the disassociated Internet content.

22. The system of claim 21, further comprising a policy activation module to activate and deactivate the disassociation policy.

23. The system of claim 21, wherein the name is indicated by one or more indications as one or more of a website category and an affiliated website.

24. The system of claim 23, further comprising a name classifier to automatically determine whether the name is the website category.

25. The system of claim 23, further comprising a Uniform Resource Locator (URL) selecting module to automatically select, based on the name, one or more URLs associated with the disassociation policy.

26. The system of claim 25, further comprising a URL review module to enable the network user with administrative authority to review and modify the one or more URLs associated with the disassociation policy.

27. The system of claim 26, wherein the policy enforcement module is to:
receive from a network user a request to access Internet content;
determine that the disassociation policy is activated and the Internet content is associated with the one or more URLs; and
based on the determination, block the Internet content and redirect the network user to a block webpage, the block webpage including the message corresponding to the Internet content.

28. The system of claim 27, wherein the policy enforcement module is to enable a deactivation of the disassociation policy with respect to the Internet content.

29. The system of claim 21, further comprising a moderation module to moderate the message corresponding to the Internet content.

30. The system of claim 21, wherein the network is a local network.

31. The system of claim 21, wherein at least one element of the disassociation policy is resident on a DNS server.

32. The system of claim 21, wherein at least one element of the disassociation policy is enforced by the DNS server.

33. The system of 21, wherein the network user with administrative authority specifies different dissociation policies based on different locations.

34. A computer readable storage medium having a program embodied thereon, the program executable by a processor in a computing device to perform a method for encouraging responsible online behavior, the method comprising:
utilizing a user interface between a network user with administrative authority and an Internet service;
receiving disassociation parameters to establish a disassociation policy for the Internet service from the network user with administrative authority via the user interface, wherein the disassociation parameters include a name associated with an Internet content and a message corresponding to the Internet content;
confirming the disassociation policy with the network user with administrative authority; and
applying the disassociation policy to a user request to access the Internet content, a policy enforcement module determining whether or not the disassociation policy is in effect to block the Internet content and to provide the network user with the message corresponding to the Internet content.

35. A method of disassociation with online content, the method comprising:
utilizing a user interface between a network user with administrative authority and the Internet service;
receiving disassociation parameters to establish a disassociation policy in the DNS Server from the network user with administrative authority via the user interface, wherein the disassociation parameters include an Internet site or category associated with an Internet content and a message to be delivered when the disassociated Internet content is requested; and
applying the disassociation policy to a network user request to access the Internet content, the DNS server determining whether or not the disassociation policy is in effect to block the Internet content and to provide the network user with the message corresponding to the disassociated Internet content.

36. The method of claim 35, wherein the network user with administrative authority specifies different dissociation policies based on different locations.

37. The method of claim 35, wherein the user interface provides a mechanism for activating and deactivating the disassociation policy in the DNS server.

38. The method of claim 35, wherein a keyword is used to generate a list of Internet sites associated Internet content for inclusion in the disassociation policy.

39. The method of claim 35, further comprising enabling the network user with administrative authority to review and modify the one or more Internet sites or categories associated with the disassociation policy in the DSN server.

40. The method of claim 35, further comprising moderating the message corresponding to the disassociated Internet content.

41. The method of claim 35, wherein the disassociation policy in the DNS server is established for a home network.

42. The method of claim 35, wherein the disassociation policy in the DNS server is established by a group of otherwise unrelated network users.

43. The method of claim 35, wherein a network user can share a disassociation policy for use in the DNS server with at least one third party.

44. The method of claim 35, wherein each end user customizes the disassociation policy in the DNS server.

45. The method of claim 35, wherein the disassociation policy for use in the DNS server is published to the Internet service from sources external to the Internet service.

46. The method of claim 35, wherein the disassociation policy for use in the DNS server is established by third parties with specific interests or advocacy viewpoints.

47. The method of claim 35, wherein the DNS server logs and reports on attempts to access the Internet categories or Internet sites associated with the disassociation policy.

48. The method of claim 35, wherein the disassociation policy for use in the DNS server is imported from a third party.

49. The method of claim 35, wherein all users of the Internet service receive notification of activation or de-activation of disassociation policies in the DNS server.

50. The method of claim 35, wherein at leas one element of the Internet service is resident on a user device.

51. The method of claim 35, wherein the mediation policy is created by a collaborative effort from more than one user.

52. The method of claim 51, wherein at least one user is not a user of the network to which the mediation policy is applied.

53. A system of disassociation with online content, the system comprising:
a user interface module to provide a user interface between a network user with administrative authority and a DNS server;
a communication module to receive disassociation parameters to establish a disassociation policy for the Internet service from the network user with administrative authority via the user interface, wherein the disassociation parameters include an Internet site or category associated with an Internet content and a message to be delivered when the disassociated Internet content is requested;
a policy generating module to establish, based on the disassociation parameters, the disassociation policy for the network; and
a policy enforcement module to apply the disassociation policy to a user request to access the Internet content, the policy enforcement module determining whether or not the disassociation policy is in effect to block the Internet content and to provide the network user with the message corresponding to the disassociated Internet content.

54. The system of claim 53, further comprising a policy activation module to activate and deactivate the disassociation policy.

55. The system of claim 53, wherein the name is indicated by one or more indications as one or more of a website category and an affiliated website.

56. The system of claim 55, further comprising a name classifier to automatically determine whether the name is the website category.

57. The system of claim 55, further comprising a Uniform Resource Locator (URL) selecting module to automatically select, based on the name, one or more URLs associated with the disassociation policy.

58. The system of claim 57, further comprising a URL review module to enable the network user with administrative authority to review and modify the one or more URLs associated with the disassociation policy.

59. The system of claim 58, wherein the policy enforcement module is to:
receive from a network user a request to access Internet content;
determine that the disassociation policy is activated and the Internet content is associated with the one or more URLs; and
based on the determination, block the Internet content and redirect the network user to a block webpage, the block webpage including the message corresponding to the Internet content.

60. The system of claim 59, wherein the policy enforcement module is to enable a deactivation of the disassociation policy with respect to the Internet content.

61. The system of claim 53, further comprising a moderation module to moderate the message corresponding to the Internet content.

62. The system of claim 53, wherein the network is a local network.

63. The system of claim 53, wherein at least one element of the Internet service is resident on a user device.

64. The system of 53 wherein the mediation policy is created by a collaborative effort from more than one user.

65. The system of claim 64, wherein at least one user is not a user of the network to which the mediation policy is applied.
